(19) United States
(12) Patent Application Publication
(10) Pub. No.: US 2008/0260051 A1
(43) Pub. Date: Oct. 23, 2008

(54) Method and apparatus for transmitting information simultaneously to multiple destinations over shared wireless resources

(76) Inventors: Federico Boccardi, Wiltshire (GB); Howard C. Huang, New York, NY (US); Matteo Trivellato, Polverara (PD) (IT)

Correspondence Address: HARNESS, DICKEY & PIERCE, P.L.C., P.O. BOX 8910, RESTON, VA, 20195, US

(21) Appl. No.: 11/790,045

(22) Filed: Apr. 23, 2007

(51) Int. Cl. H04L 27/00

(52) U.S. Cl. 375/259; 375/E07.024

(57) ABSTRACT

In a method for transmitting data, data intended for each user in a set of users is simultaneously transmitted on a plurality of spatial using common time and frequency resources during a first transmission time interval. At a user, a data stream transmitted is received on a plurality of spatial channels, wherein the plurality of spatial channels share common time and frequency resources during a given transmission interval.

### BACKGROUND OF THE INVENTION

A multi-input, multi-output (MIMO) link refers to a communication system with multiple antennas at a transmitter and a receiver. MIMO links are a known, effective way to increase link capacity of wireless links for a given bandwidth and power budget. The capacity gain results from the formation of multiple spatial channels or eigenmodes that share common wireless frequency resources.

Multiple antenna systems may provide many benefits, including spatial diversity, spatial multiplexing, and beamforming. Spatial diversity refers to the ability to collect independent received samples containing the same transmitted information, that is, namely the same transmitted data. By combining different independent received samples, the effect of channel fading may be reduced.

In spatial multiplexing, different data is transmitted on each of the multiple spatial channels. These spatial channels may be directed towards a single user to increase the users' peak rate or each channel may be directed towards multiple users. Beamforming is an example of transmitting spatially multiplexed data transmissions to multiple users. In beamforming, the phases and amplitudes of antennas at the transmitter antenna array are electronically weighted to create virtual beams. Beams may be adjusted so that it's the received power is maximized for the intended user and minimized for other users.

A transmission channel between a transmitter having M transmit antennas and multiple receivers each having N receive antennas is referred to as the MIMO broadcast channel (BC). The capacity region for the MIMO-BC may be achieved using a technique known as dirty paper coding (DPC). Conventional DPC algorithms are disclosed in Weingarten et al., “Capacity region of the MIMO broadcast channel,” appeared in IEEE Trans. Information Theory. The well-known DPC is a nonlinear technique having very high complexity and is difficult to implement.

As a less complex alternative to DPC, a class of linear architectures based on zero-forcing (ZF) beamforming may be used to achieve near-optimum performance. A conventional ZF beamforming technique is disclosed in Yoo et al., “On the Optimality of Multiantenna Broadcast Scheduling Using Zero-forcing Beamforming,” IEEE J. Select. Areas Comm., vol. 24, no. 3, pp. 528-541, March 2006; Viswanathan et al., “Downlink Capacity Evaluation of Cellular Networks with Known-Interference Cancellation,” IEEE J. Select. Areas Comm., vol. 24, no. 5, pp. 802-811, June 2003; and Spencer et al., “Zero-forcing Methods for Downlink Spatial Multiplexing in Multiuser MIMO Channels,” IEEE Trans. On Signal Processing, vol. 52, no. 2, pp. 461-471, February 2004.

These conventional ZF beamforming architectures are implemented using conventional coding (e.g., turbo codes) and linear beamforming computed with knowledge of channel state information (CSI, more specifically, phase and amplitude) at the transmitter. For example, if each of a plurality of receivers has only a single receive antenna and a transmitter has a plurality of transmit antennas, the transmitter may utilize each one of the plurality of transmit antennas to transmit a single beam to each of the plurality of receivers. In this example, each beam or antenna may be weighted such that nulls (zeros) are forced in the direction of receivers other than the receiver to which the signal is intended. That is, for example, each beam may be weighted such that receivers experience reduced interbeam interference.

A special case of the MIMO-BC is that of a single receiver with N antennas. In this case, if transmitter has knowledge of the MIMO channel, the transmitter may compute a singular-value decomposition (SVD) and form a beam for each spatial channel or eigenmode using the right unitary matrix of the SVD. Because the receiver also has knowledge of the CSI, the receiver may also compute the SVD, and use the left unitary matrix in receiving the transmitted signal. Conventionally, spatial channels are transmitted and received using unitary matrices to achieve mutual orthogonality.

### SUMMARY OF THE INVENTION

Example embodiments provide an architecture based on zero-forcing beamforming referred to as multiuser eigenmode transmission (MET). According to at least one example embodiment, a source transmits one or more spatially multiplexed data streams to one or more of receivers (also called users) based on channel information for multiple-input-multiple-output (MIMO) channels associated with each of the receivers.

An antenna array at the source may include M (where M≧1) antennas, and each of the receivers may include a respective antenna array, each of which may have N antennas (where N≧1). The antenna arrays at each of the receivers may have the same or different number of antennas.

The transmitter may utilize channel state information (CSI, e.g., phase and amplitude) at the transmitter of MIMO channels to select users for transmission, allocate one or more spatial channels to the selected receivers and/or allocate power for transmission over the plurality of spatial channels. According to at least some example embodiments, the spatial channel resources or spatial channels may be allocated to multiple receivers in a flexible manner to improve and/or optimize a one or more given performance metrics during a given transmission time interval (TTI). Example embodiments may increase spatial multiplexing order and/or result in higher transmitter throughput. Specifically, for example, for a given number of available spatial channels determined based on the number of source (or transmit) antennas and receiver antennas, these channels may be allocated among multiple users in order to improve and/or optimize the one or more performance metrics.

If the number of receivers and spatial channels is relatively large, the total number of different allocations will be relatively large. MET techniques according to example embodiments use a relatively simple algorithm to allocate spatial channels to users.

Allocated spatial channels may be mutually orthogonal to those allocated to other users. Multiple spatial channels allocated for a given user are transmitted according to a modified SVD.

According to at least one example embodiment, data may be simultaneously transmitted to each user in a set of users on a plurality of spatial channels, which use common time and frequency resources during a first transmission time interval. The plurality of spatial channels may be user-specific beams formed by electronically weighting a phase and amplitude of each transmit antenna associated with a spatial channel. The user-specific beams may be formed such that interbeam interference received by each user is reduced. The data may be transmitted to each user over at least one corresponding spatial channel.

According to at least one example embodiment, the set of users may include at least a first user, and at least one beamformed data stream to be transmitted to the first user may be generated based on channel information and at least one quality of service metric. The channel information and quality of service metric may be associated with the first user, and each of the at least one beamformed data streams may include at least a portion of data intended for the first user.

According to at least some example embodiments, a data stream may be demultiplexed into at least one data substream to be transmitted to the first user, and the at least one data substream may be processed to generate the at least one beamformed data stream. The data stream may be demultiplexed into at least one frequency band. The at least one data substream may be modulated to generate at least one modulated substream, and the at least one modulated substream may be beamformed to generate the at least one beamformed data stream.

The at least one beamformed data stream may be distributed among a plurality of antennas, and for each of a plurality of antennas, the at least one beamformed data stream may be combined with at least one other beamformed data stream distributed among the plurality of antennas. The at least one other beamformed data stream may be associated with another user.

According to at least some example embodiments, the set of users and at least one spatial channel on which to transmit data to each user in the set of users may be selected based on at least one performance metric. The set of users may be selected from a plurality of users requesting service.

According to at least one other example embodiment, a first set of users and at least one first spatial channel corresponding to each user in the first set of users may be selected based on channel information and at least one quality of service metric associated with each user in the first set of users. Data may be simultaneously transmitted to each user in the first set of users using common time and frequency resources during a first time interval. The first set of users and the at least one first spatial channel corresponding to each user may be selected using a greedy algorithm.

According to at least some example embodiments, a second set of users and at least second one spatial channel corresponding to each user in the second set of users may be selected based on channel information and at least one quality of service metric associated with each user in the second set of users. Data may be simultaneously transmitted to each user in the second set of users during a second time interval. The users in the first set of users may be different from the second set of users and/or the at least one first spatial channel may be different from the at least one second spatial channel. The second set of users and the at least one second spatial channel corresponding to each user may be selected using a greedy algorithm.

According to at least one other example embodiment, a data stream transmitted on a plurality of spatial channels may be received at a receiver. The plurality of spatial channels may share common time and frequency resources during a transmission interval. At least a first portion of the data stream may be received via a first of the plurality of spatial channels, and at least a second portion of the data stream may be received via a second of the plurality of spatial channels.

The transmitted data may be received at each one of a plurality of receiving antennas. The received signal may be processed to generate an estimate of the transmitted data stream. For example, the received signal may be processed to generate a set of modulated data substreams, and the plurality of modulated data substreams may be demodulated to generate a plurality of data substreams. Each of the plurality of data substreams may include at least a portion of the transmitted data. The plurality of data substreams may be multiplexed to generate the estimate of the transmitted data.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a portion of a UMTS wireless network according to an example embodiment;

FIG. 2 illustrates the USBB 102 of FIG. 1 in more detail;

FIG. 3 illustrates the beamforming block 206 of FIG. 2 in more detail; and

FIG. 4 illustrates a receiving user according to an example embodiment.

### DETAILED DESCRIPTION OF THE EMBODIMENTS

Although the principles of the example embodiments of the present invention may be particularly well-suited for wireless communication systems based on UMTS evolved UTRA technologies, standards and techniques, and may be described in this example context, the example embodiments shown and described herein are meant to be illustrative only and not limiting in any way. Example embodiments are also applicable to other radio networks and/or developing fourth generation (4G) wireless communication systems such as 802.16e, 802.16m, WiMax, and EV-DO Revision C. As such, various modifications will be apparent to those skilled in the art for application to other wireless communication systems and are contemplated by the teachings herein.

Where used below, the term “user” may be considered synonymous to, and may hereafter be occasionally referred to, as a mobile station, mobile, mobile user, user equipment (UE), subscriber, user, remote station, access terminal, receiver, etc., and may describe a remote user of wireless resources in a wireless communication network. The term “NodeB” may be considered synonymous to and/or referred to as a base transceiver station (BTS), base station or transmitter, and may describe equipment that provides data and/or voice connectivity between a network and one or more users. A system or network (such as an access network) may include one or more NodeBs.

In general, example embodiments may be directed to methods for transmitting and receiving data in a wireless network utilizing beamforming technologies.

As is well-known, beamforming technologies may be used to spatially separate users of a group or set who are to be simultaneously scheduled or selected to receive transmitted data in a given transmission time interval (TTI). The well-known TTI is a wireless network parameter referring to the length of an independently decodable transmission on the radio link. The TTI is related to the size of data blocks passed from the higher network layers to the radio link layer. One type of beamforming typically employed at a NodeB is user-specific beamforming. In this case, the Node B uses explicit knowledge of the users' channel state information (CSI) and creates beams tailored for each user while simultaneously reducing the effects of interbeam interference.

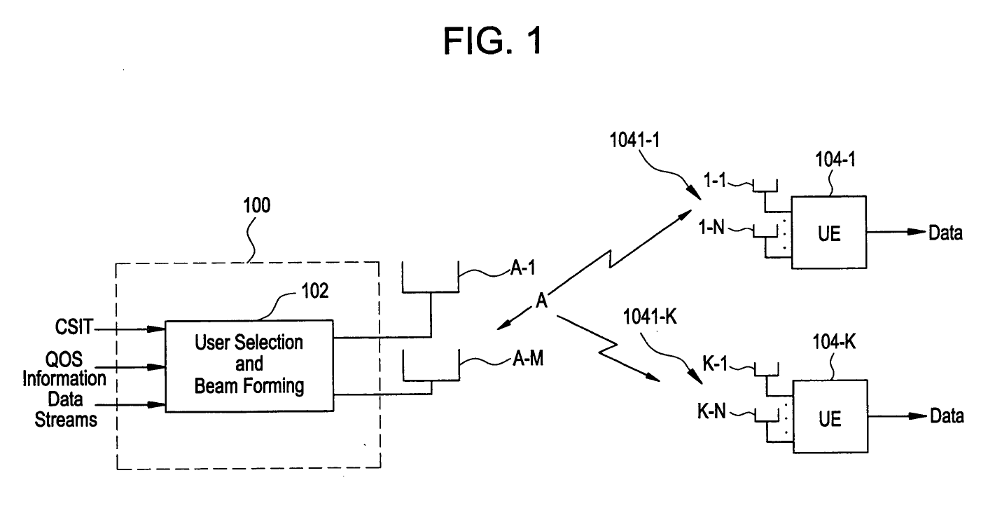

FIG. 1 illustrates a portion of a UMTS wireless network according to an example embodiment.

Referring to FIG. 1, a NodeB or transmitter 100 may have an antenna array A including M antenna elements A-1-A-M. Collectively, the antenna elements A-1-A-M transmit a beamformed signal to one or more of a plurality of users 104-1-104-K. Each of the plurality of users 104-1-104-K may have a respective antenna array 1041-1-1041-K including one or more (e.g., a plurality of) antenna elements. For example, antenna array 1041-1 at user 104-1 may include N antennas 1-1-1-N, and antenna array 1041-K at user 104-K may include N antennas K-1-K-N. Although discussed herein with regard to the same number of antennas, each of users 104-1-104-K may have the same or a different number of antennas. Each antenna array 1041-1-1041-K is capable of receiving a beamformed signal transmitted from the antenna array A at the NodeB 100.

Still referring to FIG. 1, the NodeB 100 may further include a user selection and beamforming block (USBB) 102. As shown, the USBB 102 may generate a plurality of beamformed signals for transmitting data to the plurality of users 104-1-104-K based on CSI and quality of service (QoS) information associated with each of the plurality of users 104-1-104-K. The NodeB 100 may transmit the beamformed signals using the plurality of antennas A-1-A-M, each of which may share the same time and frequency resources during a given TTI.

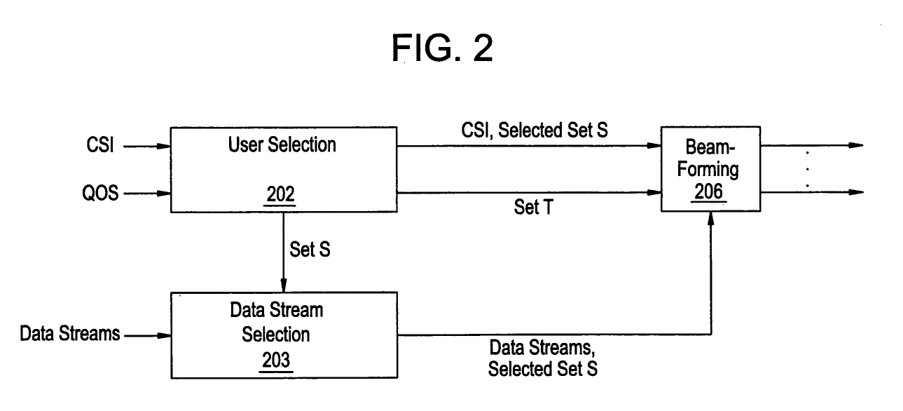

FIG. 2 illustrates the USBB 102 of FIG. 1 in more detail. For example purposes, a detailed description of processes performed at the USBB 102 will be described with regard to FIGS. 1 and 2. This example discussion considers a multi-band, multi-antenna downlink channel model in which each band f (where f=1, . . . , F) is modeled as a MIMO Gaussian broadcast channel. For the purposes of this discussion, each of K users 104-1-104-K equipped with N receive antennas, requests service from the transmitter 100 having M antennas, and F is assumed to be the number of available frequency resource blocks. For example, if the available bandwidth is 5 MHz, there are F=8 resource blocks of 375 KHz each. Each resource block is assumed to be a contiguous cluster of 25 subcarriers. Example embodiments, however, are not limited thereto.

Referring to FIG. 2, CSI and QoS information for each of the plurality of users 104-1-104-K may be input to a user selector 202. As is well-known, CSI may be determined at the NodeB 100 based on channel estimates. Well-known channel estimates may be acquired based on, for example, pilot signals transmitted via an uplink signaling channel (e.g., between user and NodeB) in time-division duplexed systems. Alternatively, CSI may be determined at the NodeB 100 based on explicit feedback from the users. This method for determining CSI is also well-known in the art. Each users' QoS information may be determined at a higher layer, as is also well-known. QoS information may include QoS metrics such as minimum delay, average achieved rate, data queue size, etc. for each of the plurality of users 104-1-104-K.

Still referring to FIG. 2, the user selector 202 may select a set of users S for transmission during a given TTI, and for each user in the set S, a set of spatial channels or eigenmodes on which data is to be transmitted may be allocated to users in the set S. The set S and the associated, allocated spatial channels may be selected based on the input CSI and QoS information.

That is, for example, for each TTI, the user selector 202 may select a set of users S to receive data, and for each user k in the set S (kεS), the user selector 202 may allocate a set of spatial channels E_{k,f} on each band f=1, . . . , F to be used in transmitting data to the users in the set S. The set S and associated, allocated spatial channels associated with each user k in the set S may be collectively referred to as set T.

According to at least one example embodiment, T may be chosen using a weighted sum rate criterion (also referred to as a performance metric) associated with each of the K users. For example, T may be chosen so as to maximize a weighted sum rate associated with a given TTI

For a given set of users S, the weighted rate for the kth user within the set S is given by

$${a}_{k} {\sum }_{j ∈ {E}_{k}} log ( 1 + {\vec{σ}}_{j}^{{( k )}^{2}} {w}_{j}^{( k )} ) ,$$

where aₖ is the QoS weight or QoS metric associated with user k, σ̅ⱼ^{(k)}^{²} is the power delivered to the kth user's jth spatial channel as a function of beamforming, and wⱼ^{(k)} is the power allocated to the jth spatial channel of kth user.

A brief example for maximizing a weighted sum rate metric for a given set T (in which T represents a set of users S and spatial channels Eₖ (kεS)) will now be discussed. According to at least one example embodiment, the weighted sum rate metric for given a set T and the set of QoS weights for the users within the set S a=[a₁, . . . , a_{K}]^{H} may be maximized by solving a power allocation problem given by equation (1) below.

$$R ( T , a ) = {max}_{{w}_{j}^{( k )}} {\sum }_{k ∈ S} {a}_{k} {\sum }_{j ∈ {S}_{k}} log ( 1 + {\overline{σ}}_{j}^{{( k )}^{2}} {w}_{j}^{( k )} ) subject to \{ \begin{matrix}{w}_{j}^{( k )} \geq 0 , k ∈ S , j ∈ {E}_{k} & \\ {\sum }_{k ∈ S} {trW}_{k} \leq P & .\end{matrix} \qquad ( 1 )$$

In equation (1), the weighted sum rate metric for a given set T is

$${\sum }_{k ∈ S} {a}_{k} {\sum }_{j ∈ {E}_{k}} log ( 1 + {\overline{σ}}_{j}^{{( k )}^{2}} {w}_{j}^{( k )} ) .$$

Given equation (1), the optimum transmit powers wⱼ^{(k)} may be generated using the well-known weighted waterfilling in

$${\sum }_{k ∈ S} \vert {E}_{k} \vert$$

dimensions.

Finding the optimum set T for solving

$${max}_{T} R ( T , a )$$

requires a brute force search over all possible allocations of spatial channels per band where the number of spatial channels depends on the number of transmitter and receiver antennas. The maximum total number of transmitted spatial channels is min(M,KN), and the maximum number of receiver spatial channels per user is min(M,N). For example, if there are M=2 transmitter antennas, K=3 users each with N=2 antennas, the NodeB may transmit up to 2 spatial channels, and each user may receive up to 2 spatial channels.

Assuming for example purposes, three users are labeled A, B and C, there exists nine options for allocating channels to the three users represented by: (A), (B), (C), (AA), (BB), (CC), (AB), (BC) and (AC), where the letters indicate which users are allocated spatial channels. In the first three options ((A), (B), (C)), only a single channel is allocated. In the next three options ((AA), (BB), (CC)), both channels are allocated to a single receiver. In the last three options ((AB), (BC) and (AC)), the two channels are multiplexed between different receivers.

In another example, if there are 4 spatial channels and 3 receivers, the spatial channels may be allocated as (AABC). That is, namely, two channels may be allocated for user A, and one channel is allocated for each of users B and C. As will be discussed in more detail below, the channels allocated for user A may be transmitted and received based on the SVD of its associated MIMO channel, and the transmissions among the 3 receivers may be mutually orthogonal in the zero-forcing beamforming sense.

Conventionally, finding the optimum allocation set T requires considering allocating 1, 2, . . . , min(M,KN) spatial channels per band. Thus, the total number of sets to consider is

$${[ {\sum }_{j = 1}^{min ( M , KN )} \frac{( KN ) !}{( KN - j ) ! j !} ]}^{F} .$$

For example, for a set of parameters M=4, K=10, N=4, F=8, the number of sets to be considered using brute force is on the order of 1×10⁴⁰ which is computationally infeasible.

Example embodiments, however, utilize a more efficient, greedy algorithm for determining T.

The following is an explanation of an example greedy algorithm for determining T. This example will be discussed with regard to the following pseudo-code for illustrative purposes. This pseudo-code represents a process that may be performed at the user selector 202.

In this example, optimization may be performed for a given user and spatial channel allocation T. The set of all K users and spatial channels may be defined as T_{A}. Assuming N<M, where N is the number of spatial channels or receiving antennas available at each user, and M is the number of transmit antennas at the NodeB, there are a total of KN spatial channels in set T_{A}. On the jth iteration, tⱼ is the one or more candidate spatial channels chosen among the available spatial channels associated with any user in the set S. The pseudo-code is as follows.

initialization. Let j = 1, T₀ = Ø, R(Ø) = 0, and Done = 0.
while (j ≦ min(KN, M)) and (not Done)

$find {t}_{j} = {arg max }_{\frac{t ∈ {T}_{A}}{{T}_{j - 1}}} R ( {T}_{j - 1} ⋃ \{ t \} )$
if R(Tⱼ₋₁ ∪{t}) < R(Tⱼ₋₁)

Tⱼ = Tⱼ₋₁
Done = 1

else

Tⱼ = Tⱼ₋₁ ∪{tⱼ})
j = j + 1

end

end
T = Tⱼ

Referring to the above pseudo code, on the first iteration (j=1), the selected spatial channels t₁ will be the globally dominant or best spatial channels. That is, for example, the selected spatial channels t₁ having the largest associated eigenvalue among all of the KN spatial channels.

After having selected the best spatial channels among all available spatial channels in the set T_{A}, a weighted rate metric Rₜ₁ associated with the selected spatial channel t₁ is calculated. Keeping this spatial channel, a second spatial channel t₂ may be chosen from the remainder of spatial channels in the set T_{A}. The second spatial channel t₂ may be chosen such that the weighted sum rate metric R_{t1,2} for the combination of the spatial channels t₁ and t₂ is maximized. If this weighted sum rate metric R_{t1,2} is greater than the weighted rate metric R₁, then the first and second spatial channel and the associated weighted sum rate metric R_{t1,2} is retained, and the process continues by searching for a third next spatial channel t₃ among the remaining spatial channels that maximizes the weighted sum rate metric R_{t1,2,3} for a combined three spatial channels. Otherwise, the second spatial channel is discarded, the single spatial channel t₁ and associated weighted rate metric R₁ is retained, and the search algorithm terminates.

Returning to FIG. 2, the CSI associated with the selected set S along with the set T may be output from the user selector 202 to the beamforming block 206. The selected set S may also be output from the user selector 202 to the data stream selector 203. The data stream selector 203 may select data streams associated with the users in the set S and output the selected data streams to the beamforming block 206. Methods for selecting these data streams are well-known in the art and thus a detailed discussion has been omitted for the sake of brevity.

The beamforming block 206 may generate at least one beamformed data stream intended for each user and spatial channel in the set T based on the CSI associated with each user in the set S, the set of selected spatial channels and users in the set T and the selected data streams from the data stream selector 203.

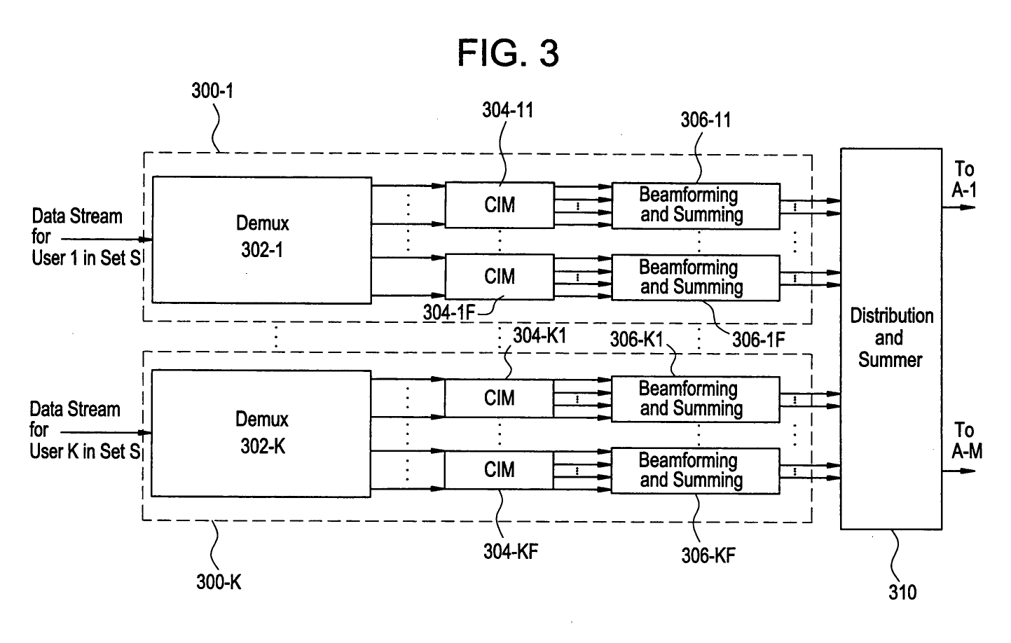

FIG. 3 illustrates the beamforming block 206 in more detail. A more specific example will be described to illustrate the functions and operations performed at the beamforming block 206. However, it will be understood that this example is for illustrative purposes only, and not intended to be limiting.

For the purposes of the following discussion, assume Iₖ [symbol] {1, . . . , F} denotes the set of frequency bands for the kth user on which at least one spatial channel is transmitted, and |X| denotes the cardinality of set X. For example, if |E_{1,1}|=3, |E_{1,2}=4, E_{2,1}=1, |E_{2,2}=0, then |I₁=2, |I₂|=1. In this example, a first user (e.g., 104-1 in FIG. 1) is allocated a total of 7 spatial channels on 2 bands while a second user (e.g., 104-2) is allocated only 1 spatial channel. With M antennas at the transmitter 100, there are enough degrees of freedom to transmit at most the lesser of M and N (e.g., min(M,N)) spatial channels per user per band, and thus,

$${\sum }_{k ∈ S} \vert {E}_{k , f} \vert \leq M$$

for f=1, . . . , F. Also assumed for the purposes of this example, is that each of K users 104-1-104-K in FIG. 1 is included in the set T, and |Iₖ|=|Iⱼ|=F is the case for all of users in the set T.

Referring to FIG. 3, data streams for each of the plurality of users 104-1-104-K may be input to a corresponding one of a plurality of beamforming processing blocks 300-1-300-K. Each beamforming processing block 300-1-300-K may process a corresponding user's data stream to generate at least one beamformed data stream associated with each of the users in the set S, and distribute the users' corresponding beamformed data stream(s) over the M antennas A-1-A-M at the NodeB 100. Each of the beamforming processing blocks 300-1-300-M may function in the same manner, and thus, only the beamforming block 300-1 will be discussed in detail for the sake of brevity.

With regard to the beamforming processing block 300-1, a data stream intended for a user 104-1 may be demultiplexed into |Iₖ| substreams (where |Iₖ|≧1) at a demultiplexer 302-1. These substreams may be coded, interleaved and modulated at a corresponding one of CIM blocks 304-11-304-1F to generate a plurality of modulated symbols or substreams d_{k,f}, fεIₖ. The dimensionality of this vector is given by the number of spatial channels assigned to user in band f: |E_{k,f}|.

The plurality of modulated symbols d_{k,f}, fεIₖ may be further processed at the beamforming and summing blocks 306-11-306-1F to generate at least one beamformed data stream. That is, for example, each of the plurality of modulated symbols d_{k,f}, fεIₖ may be multiplied by a matrix G_{k,f}, at one of a plurality of beamforming and summing blocks 306-11-306-1F. The matrix G_{k,f} may be an M-by-|E_{k,j}| MET beamforming matrix which will be described in more detail below. The resultant beamformed data streams generated at each beamforming and summing block 306-11-306-1F may be output to a distribution and summation block 310.

The distribution and summation block 310 distributes the resultant combination from each of the beamforming and summing blocks 306-11-306-1F appropriately to each of the M transmit antennas and sums the beamformed data streams to generate a resultant beamformed data stream, which is then further processed (as is well-known in the art) into at least one signal. The transmitted signal on band f is represented by

$${x}_{f} = {\sum }_{k ∈ S} {G}_{k , f} {d}_{k , f} ,$$

where x_{f} is an M-dimensional vector.

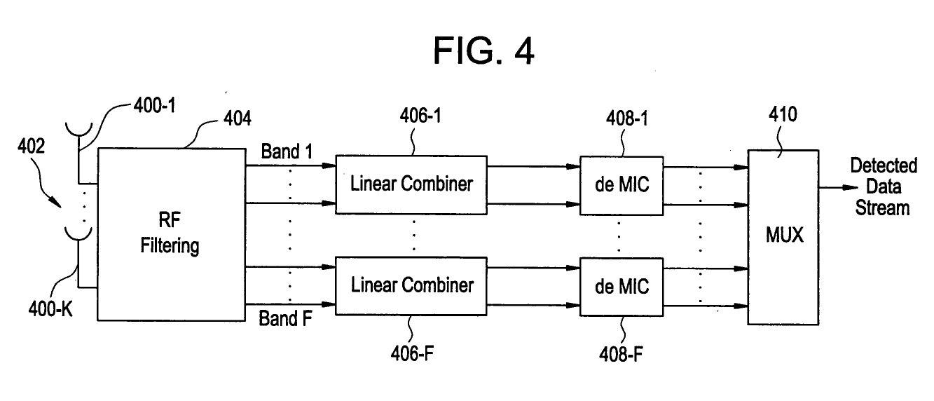

Returning to FIG. 1, one or a plurality of signals x_{f} may be transmitted to user 104-1. FIG. 4 illustrates the user 104-1 in more detail.

At the kth user (e.g., user 104-1, in this example), the user may receive a transmitted signal via antenna array 402, which may include a N antenna elements 400-1-400-N, wherein N≧1). The received signal may be converted from radio frequency (RF) to baseband at RF filtering block 404 to generate a complex baseband signal. The RF filtering block 404 may generate the complex baseband signal in any well-known manner. The complex baseband received signal on band f is represented by y_{k,f}=H_{k,f}x_{f}+n_{k,f}, k=1, . . . , K; f=1, . . . , F, where y_{k,f} is an N-dimensional vector, H_{k,f}εC^{N×M} is the kth user's MIMO channel matrix (assuming for example purposes flat fading over each band f), and n_{k,f}˜CN(0, 1) is the complex additive white Gaussian noise at the kth user on band f.

According to example embodiments, a given user receives data only on those bands allocated to the particular user. These allocated bands are referred to as a user's active bands. The complex additive white Gaussian noise n_{k,f}˜CN(0, 1) may account for intercell and/or intersector interference experienced by the kth user. For the purposes of this example discussion, it is assumed that all of the kth user's MIMO channels over all bands are known at the NodeB 100.

At the kth user (e.g., user 104-1), the received signal on each active band is demodulated using a corresponding one of a plurality of linear combiners 406-1-406-F. Each linear combiner 406-1-406-F demodulates an active band by multiplying the complex baseband signal y_{k,f} from the RF filterblock 404 with an |E_{k,f}|-by-N matrix to generate an estimate of the symbol d_{k,f}. The soft-symbols d_{k,f} are output to a corresponding one or a plurality of demodulator, de-interleaver, decoder blocks (DEMIC) 408-1-408-F. Each DEMIC block 408-1-408-F generates an estimate of the transmitted |Iₖ| substreams based on the soft-symbols output from a corresponding one of the plurality of linear combiners 406-1-406-F. The estimate of the transmitted |Iₖ| substreams are output from each of the DEMIC blocks 408-1-408-F to a multiplexer 410. The multiplexer 410 multiplexes the |Iₖ| substreams to generate an estimate of the data stream transmitted by the NodeB 100 to the kth user (e.g., user 104-1 in this example).

Because the beamforming block 206 and receiver at the user operate independently in each band, the notation may be simplified by dropping the subscript f from the transmitted signal x, the MIMO channel matrices Hₖ, and the spatial channel index set Eₖ.

Processes performed at the user 104-1 will now be described in more detail for the sake of clarity, and to illustrate that in some ideal cases, a signal may be received at the receiver with little or zero interference utilizing example embodiments. The channel of the kth user (e.g., user 104-1) may be decomposed using singular value decomposition (SVD) as Hₖ=UₖΣₖVₖ^{H}, where the eigenvalues in Σₖ are arranged so that the ones associated with the allocated set of spatial channels Eₖ appear in the leftmost column. These eigenvalues are denoted as Σ_{k,1}, . . . , Σ_{k,|E}_{ₖ}_{|}.

In at least this example, the kth user's receiver may be a linear detector given by the Hermitian transpose of the leftmost columns of Uₖ denoted as u_{k,1}, . . . , u_{k,|E}_{ₖ}_{|}. Likewise, the leftmost columns of the matrix Vₖ is denoted as v_{k,1}, . . . , v_{k,|E}_{ₖ}_{|}. Given the above, the signal following the detector may be represented by equation (2)

$$\begin{matrix}{r}_{k} = {[ {u}_{k , 1} … {u}_{k , \vert {E}_{k} \vert} ]}^{H} {y}_{k} \\ = {Γ}_{k} {G}_{k} {d}_{k} + {Γ}_{k} {\sum }_{j ∈ S , j \neq k} {G}_{j} {d}_{j} + {n}_{k}^{′}\end{matrix} \qquad ( 2 )$$

In equation (2), yₖ is the above-discussed received signal, nₖ is the processed noise, and Γₖ=[Σ_{k,1}v_{k,1} . . . Σ_{k,|E}_{ₖ}_{|}v_{k,|E}_{ₖ}_{|}]^{H} is an |Eₖ|×M matrix. By defining \tilde{H}ₖ=[|Γ₁^{H} . . . Γₖ₋₁^{H}Γₖ₊₁^{H} . . . Γ_{|S|}^{H}]^{H}, a zero-forcing constraint requires that Gₖ lie in the null space of \tilde{H}ₖ. Thus, Gₖ may be determined by considering the SVD of \tilde{H}ₖ represented by equation (3).

\tilde{H}ₖ=Ũₖ\tilde{Σ}ₖ[\tilde{V}ₖ⁽¹⁾\tilde{V}ₖ⁽⁰⁾]^{H}, (3)

In equation (3), Vₖ⁽⁰⁾ corresponds to the right eigenvectors associated with null modes.

The kth user's precoder matrix is given by Gₖ=\tilde{V}ₖ⁽⁰⁾Cₖ. This matrix may be used as the matrix at the linear combiners in each of beamforming processing blocks 300-1-300-K. Because Hₖ\tilde{V}ₖ⁽⁰⁾=0 for all kεS, ΓₖGⱼ=Γₖ\tilde{V}ⱼ⁽⁰⁾Cⱼ=0 for j≠k and any choice of Cⱼ. Therefore, the received signal for the kth user after combining contains no interference. That is, for example, rₖ=ΓₖGₖdₖ+nₖ.

An SVD Γₖ\tilde{V}ₖ=Ūₖ[ Σ̅ₖ 0][ V̅ₖ⁽¹⁾ V̅ₖ⁽⁰⁾]^{H}, may be performed, where Σ̅ₖ is the |Eₖ|×|Eₖ| diagonal matrix of eigenvalues, and Cₖ= V̅ₖ⁽¹⁾. From equation (3), the resulting weighted rate for the kth user is

$${a}_{k} {\sum }_{j ∈ {E}_{k}} log ( 1 + {\overline{σ}}_{j}^{{( k )}^{2}} {w}_{j}^{( k )} ) ,$$

where σ̅ⱼ^{(k)}^{²} is the jth diagonal element of Σ̅ₖ² (jεEₖ), and wⱼ^{(k)} is the power assigned to this spatial channel.

The detector for the kth receiver may require knowledge of the precoding vectors (or precoding vector information) for other users j, where j≠k, jεS. This information may be transmitted to the kth user on a control channel. Alternatively, these vectors (or preceding vector information) may be directly estimated by the kth user based on precoding pilot signals required for channel estimation. Methods for doing so are well-known and thus a detailed discussion will be omitted for the sake of brevity.

Example embodiments enable data to be transmitted on users' spatial channels, while suppressing and/or eliminating distinctions between single-user and multi-user MIMO techniques by dynamically deciding during each transmission time interval (TTI) how many and which users to serve. Using example embodiments, a transmitter may transmit multiple spatial streams to a single user, a single spatial stream to multiple users, or multiple spatial streams to multiple users.

Because the channels of all users are assumed to be known at the NodeB, spatial channels transmitted to different users may be weighted using a zero-forcing criterion such that the spatial channels are mutually orthogonal. That is, for example, a given user may experience no interference from spatial channels intended for other users. Groups of spatial channels among users are mutually orthogonal due to zero-forcing; however, spatial channels for any given user are mutually orthogonal due to the SVD.

The class of zero-forcing beamforming systems may be asymptotically optimum for a given M and N, as the number of users per sector increases without bound.

According to example embodiments, the number of orthogonal beams that may be formed at the transmitter is less than or equal to the number of transmit antennas M. On the other hand, the number of spatial channels that may be simultaneously received per user is no more than the lesser of M or N (min(M, N)). These limits are for a given band; therefore for a more general multiband (OFDM) case with F bands (resource blocks), these limits become FM and min(FM, FN), respectively.

So far, as discussed herein, example embodiments assume the base station has ideal or nearly ideal knowledge of users' MIMO channels when performing beamforming operations. This may be the case in time-division duplexed (TDD) systems where the same frequency bands are used on the uplink and downlink. In this case, MIMO channel estimates obtained by the base station on the uplink which are relatively highly reliable may be used for MET beamforming on the downlink.

In frequency-division duplexed (FDD) systems, the channel information may be explicitly fed back on an uplink channel from the users to the base station. Therefore, considering techniques to reduce the amount of feedback may be beneficial. According to Boccardi et al., “A near-optimum technique using linear precoding for the MIMO broadcast channel,” in IEEE ICASSP Proceedings, 2007, when M is relatively small compared to the number of users K vying for service, the sum rate may be maximized when a single stream is transmitted to each of M receivers. In addition, for each user, the spatial channel on which the data stream is transmitted may be associated with a dominant eigenmode. That is, for example, for each user, the spatial channel corresponding to the largest eigenvalue of the MIMO channel's singular value decomposition may be chosen for transmission each TTI. Even though a user with multiple antennas may demodulate multiple eigenmodes, the amount of feedback required to specify the channel information for MET beamforming may be reduced by restricting the user to receive a single eigenmode.

Because of the limited bandwidth of the uplink feedback channel, the downlink channel state information (CSI) at the base station transmitter may not be exact or ideal. As a result, the zero-forcing beamforming may not be exact in the sense that serviced users may receive residual interbeam interference.

Under imperfect CSI or if a user receives residual interbeam interference, spatial processing via multiple antennas at the user may be used to mitigate the interference. As an example, each user may use a minimum mean-squared error (MMSE) detector, as described in S. Verdu, Multiuser Detection, Cambridge University Press, 1998, to suppress and/or eliminate interbeam interference.

The invention being thus described, it will be obvious that the same may be varied in many ways. Such variations are not to be regarded as a departure from the invention, and all such modifications are intended to be included within the scope of the invention.

We claim:

1. A method for transmitting data from a transmitter to each user in a set of users simultaneously, the method comprising:
simultaneously transmitting, on a plurality of spatial channels, respective data to each user in the set of users using common time and frequency resources during a first transmission time interval.

2. The method of claim 1, wherein the plurality of spatial channels are user-specific beams formed by electronically weighting a phase and amplitude of each transmit antenna associated with a spatial channel.

3. The method of claim 2, wherein the user-specific beams are formed such that interbeam interference received by each user is reduced.

4. The method of claim 3, wherein the simultaneously transmitting step transmits data to each user over at least one corresponding spatial channel.

5. The method of claim 1, wherein the set of users includes at least a first user, the method further comprising:
generating at least one beamformed data stream to be transmitted to the first user based on channel information and at least one quality of service metric, the channel information and quality of service metric being associated with the first user, and each of the at least one beamformed data streams including at least a portion of data intended for the first user; and wherein
the simultaneously transmitting step transmits the at least one beamformed data stream to the first user on at least one of the plurality of spatial channels.

6. The method of claim 5, wherein the generating step further comprises:
demultiplexing a data stream into at least one data substream to be transmitted to the first user; and
processing the at least one data substream to generate the at least one beamformed data stream.

7. The method of claim 6, wherein the demultiplexing step demultiplexes the data stream into at least one frequency band.

8. The method of claim 6, wherein the processing step further comprises:
modulating the at least one data substream to generate at least one modulated substream; and
beamforming the at least one modulated substream to generate the at least one beamformed data stream.

9. The method of claim 6, further comprising:
distributing the at least one beamformed data stream among a plurality of antennas, and
combining, for each of a plurality of antennas, the at least one beamformed data stream with at least one other beamformed data stream distributed among the plurality of antennas.

10. The method of claim 9, wherein the at least one other beamformed data stream is associated with another user.

11. The method of claim 1, further comprising:
selecting, based on at least one performance metric, the set of users and at least one spatial channel on which to transmit data to each user in the set of users, the set of users being selected from a plurality of users requesting service; wherein
the simultaneously transmitting step transmits data to each user on at least one of the plurality of spatial channels.

12. A method for transmitting data from a transmitter to each user in a set of users, the method comprising:
first selecting a first set of users and at least one first spatial channel corresponding to each user in the first set of users based on channel information and at least one quality of service metric associated with each user in the first set of users; and
simultaneously transmitting data to each user in the first set of users using common time and frequency resources during a first time interval.

13. The method of claim 12, wherein the first selecting step selects the first set of users and the at least one first spatial channel corresponding to each user using a greedy algorithm.

14. The method of claim 12, further comprising:
second selecting a second set of users and at least second one spatial channel corresponding to each user in the second set of users based on channel information and at least one quality of service metric associated with each user in the second set of users; and
simultaneously transmitting data to each user in the second set of users during a second time interval; wherein
the users in the first set of users are different from the second set of users.

15. The method of claim 14, wherein the second selecting step selects the second set of users and the at least one second spatial channel corresponding to each user using a greedy algorithm.

16. The method of claim 12, further comprising:
second selecting a second set of users and at least second one spatial channel corresponding to each user in the second set of users based on channel information and at least one quality of service metric associated with each user in the second set of users; and
simultaneously transmitting data to each user in the second set of users during a second time interval; wherein
the at least one first spatial channel is different from the at least one second spatial channel.

17. The method of claim 16, wherein the second selecting step selects the second set of users and the at least one second spatial channel corresponding to each user using a greedy algorithm.

18. A method for receiving transmitted data, the method comprising:
receiving, at a receiver, a data stream transmitted on a plurality of spatial channels, the plurality of spatial channels sharing common time and frequency resources during a transmission interval, at least a first portion of the data stream being received via a first of the plurality of spatial channels, and at least a second portion of the data stream being received via a second of the plurality of spatial channels.

19. The method of claim 18, wherein the receiving step receives the transmitted data at each one of a plurality of receiving antennas.

20. The method of claim 18, wherein the receiving step further comprises:
processing the received signal to generate an estimate of the transmitted data stream.

21. The method of claim 20, wherein the processing step processes the received signal based on preceding information associated with at least one user to generate the estimate of the transmitted data stream.

22. The method of claim 20, wherein the processing step further comprises:
processing the received signal to generate a set of modulated data substreams;
demodulating the plurality of modulated data substreams to generate a plurality of data substreams, each of the plurality of data substreams including at least a portion of the transmitted data; and
multiplexing the plurality of data substreams to generate the estimate of the transmitted data.
